(19) United States
(12) Patent Application Publication
(10) Pub. No.: US 2004/0175532 A1
(43) Pub. Date: Sep. 9, 2004

(54) Non-clumping fabric and extruding method

(76) Inventor: John Rainbolt, East Palo Alto, CA (US)

Correspondence Address: PERKINS COIE LLP, P.O. BOX 2168, MENLO PARK, CA, 94026, US

(21) Appl. No.: 10/384,216

(22) Filed: Mar. 6, 2003

(51) Int. Cl. B32B 27/04; B32B 1/04

(52) U.S. Cl. 428/74; 428/76; 442/268; 442/274; 442/277; 442/285; 442/286

(57) ABSTRACT

The present invention teaches systems and methods for providing a non-clumping insulating fabric suitable for use in clothing and bedding comprising: a fiber fill layer comprising a plurality of fibrous insulative elements; an adhesive layer having an adhesive surface for binding material coming in contact with the adhesive surface; wherein each insulative element of the fiber fill layer is bound to the adhesive surface forming a continues layer of secured insulative elements; repeating this layering process to reach a desired insulative value; and wherein the adhesive layer and the fiber fill layer are at least partially enclosed by a cover for preventing the fibrous elements from being dislodged from the adhesive layer and preventing the fibrous elements from being soiled.

### FIELD OF THE INVENTION

The present invention pertains to the field of fabric laminates containing down or similar insulative material. More particularly to the manufacture and structure of a non-clumping insulative fabric containing down which can be used in a manner consistent with woven fabrics.

### BACKGROUND OF INVENTION

It is well known in the art that down or down compositions provide excellent thermal insulation for the reason that the down is very fluffy and traps air which provides excellent insulation. Generally such down articles are formed by creating baffles containing down within the article. However, because down is not secured in place it tends to deposit in small areas of such baffles. Another problem with down-fill lining is that the down can be displaced within the lining and congregate in certain portions thereof where it then provides increased insulation while in other portions of the lining the insulating value is reduced. Such “clumping” makes conventional down filled articles less than optimally efficient as thermal insulators. Also down filled fabrics cannot be cut to needed shapes, because the down filling would leak out.

Furthermore, conventional down filled articles tend to be bulky because the down filling is not evenly distributed. The thicker the fluff in the lining of such an article, the more insulating value is achieved and the bulkier the article is. This has a disadvantage in that such an article must be relatively bulky in order to provide insulation from cold. Because of the above existing problems, other insulating materials are used as inner linings, such as synthetic fibers. However, synthetic fibers cannot replace the comfort, look and feel of down, which is a natural product. Furthermore, down is a natural and biodegradable agent, which might not be considered a pollutant if released into the environment, unlike similar synthetic materials.

PRIOR ART FIG. 1 shows one conventional quilted, down filled comforter 10 in accordance with the prior art. Comforter 10 includes a plurality of baffles 12 arranged in a grid. Each baffle 12 is bordered by a seam 14 creating an enclosed area 16. Within enclosed area 16 is a clump of down feathers 18. Because down 18 tends to congregate in the bottom of such enclosed areas 16, much of the enclosed area 16 is empty, providing poor insulative properties and giving a lumpy feel.

What is a needed is a down fabric that provides good uniform insulation and can be cut to any needed shape. Further needed is a down fabric that does not clump, and maintains a uniform soft feel. Further needed is a low cost system and method for the manufacture of such a fabric.

### SUMMARY OF THE INVENTION

The present invention provides a down fabric that provides good uniform insulation and can be cut to any needed shape. Further provided is a down fabric that does not clump, and maintains a uniform soft feel similar to conventional down filled articles. The present invention also teaches a low cost system and method for the manufacture of such a fabric. Further provided is a low cost insulative material suitable for use in specialized construction applications such as residential structures.

A first embodiment of the present invention includes a non-clumping insulating fabric suitable for use in clothing and bedding comprising: a fiber fill layer comprising a plurality of fibrous insulative elements; an adhesive layer, or an extruded layer, having an adhesive surface for binding material coming in contact with the adhesive surface; and wherein each insulative element of the fiber fill layer is bound to the adhesive surface forming a continues layer of secured insulative elements. In accordance with a preferred embodiment, the adhesive layer and the fiber fill layer are at least partially enclosed by a cover for preventing the fibrous elements from being dislodged from the adhesive layer and preventing the fibrous elements from being soiled. The fabric further includes a second adhesive layer, the second adhesive layer being deposited upon the second fiber fill layer such that at least some of the insulative elements of the second insulative layer bind to the second adhesive layer; a third fiber fill layer applied over the second adhesive layer such that insulative elements of the third fiber fill layer bond with the second adhesive layer; and wherein the cover is comprised of an upper sheet applied over the third fiber fill layer and a lower sheet in proximity with the first fiber fill layer, wherein the upper sheet and the lower sheet are connected with a common seam, and wherein the cover is composed of permeable cloth. In accordance with this embodiment the insulative elements include natural down feathers.

In one embodiment of the present invention, the fiber fill layer is a first fiber fill layer, and wherein the plurality of fibrous insulative elements is a first plurality, further comprising a second plurality of fibrous insulative elements deposited upon the adhesive layer forming a second fiber fill layer, wherein each insulative element of the second adhesive layer is bound to the adhesive layer.

In another embodiment of the present invention is taught a method for manufacturing non-clumping insulating fabric suitable for use in clothing and bedding comprising: providing a first plurality of insulative elements distributed over a surface forming a first insulative layer; depositing upon the first insulative layer an adhesive layer having an adhesive surface for binding material coming in contact with the adhesive surface, wherein the first plurality of insulative elements bonds to the adhesive surface; depositing upon the first adhesive layer a second plurality of insulative elements such that each element of the second plurality of insulative elements adheres to the adhesive layer forming a second insulative layer; enclosing the first and second insulative layers in a cover such that the insulative elements are protected from an outside environment. Additional adhesive layers and insulative layers may also be deposited in order to form a muli-layered inuslating fabric of any desired thickness.

The above embodiments are intended only as examples of ways in which the present invention may be practiced. It will be understood by those skilled in the art that variations on these embodiments could also be practiced in the spirit of the scope of the present invention. Accordingly, the present invention should not be limited by these specific disclosed embodiments.

### BRIEF DESCRIPTION OF THE DRAWINGS

FIG. 1 illustrates a down filled comforter in accordance with the prior art,

FIG. 2 is an exploded perspective view of an insulating composite structure in accordance with one embodiment of the present invention;

FIG. 3 is a flow chart diagram illustrating a process for forming a non-clumping down fabric in accordance with one embodiment of the present invention;

FIG. 4 is a cross-sectional cut away view of a non-clumping down fabric created in accordance with one embodiment of the present invention;

FIG. 5 is a perspective view showing how an individual goose down feather is secured within one embodiment of the present invention;

FIG. 6 is a perspective block diagram illustrating a conveyor assembly system for manufacturing non-clumping down fabric in accordance with one embodiment of the present invention;

FIG. 7 is a perspective block diagram illustrating a three dimensional down filled structure in accordance with one-embodiment of the present invention; and

FIG. 8 is a cross-sectional cut away end view of a non-clumping down fabric comprising a plurality of the three dimensional down filled structures of FIG. 6 in accordance with one embodiment of the present invention.

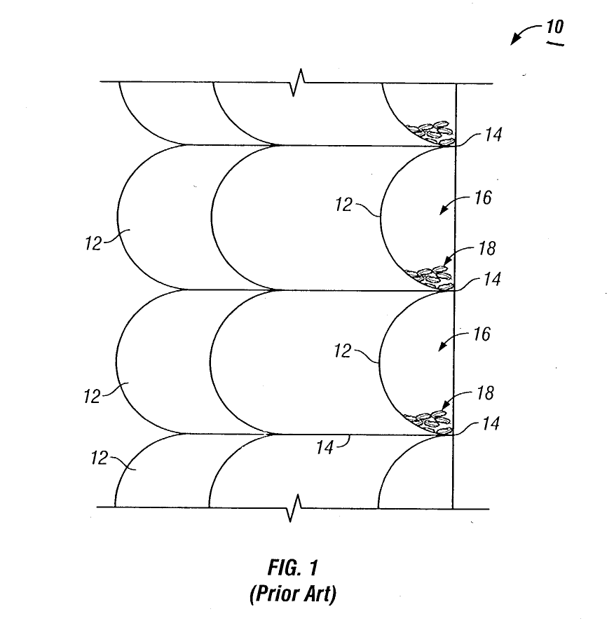

### DETAILED DESCRIPTION OF THE PREFERRED EMBODIMENT

A first embodiment of the present invention includes a non-clumping insulating fabric suitable for use in clothing and bedding comprising: a fiber fill layer comprising a plurality of fibrous insulative elements; an adhesive layer having an adhesive surface for binding material coming in contact with the adhesive surface; wherein each insulative element of the fiber fill layer is bound to the adhesive surface forming a continues layer of secured insulative elements; and wherein the adhesive layer and the fiber fill layer are at least partially enclosed by a cover for preventing the fibrous elements from being dislodged from the adhesive layer and preventing the fibrous elements from being soiled.

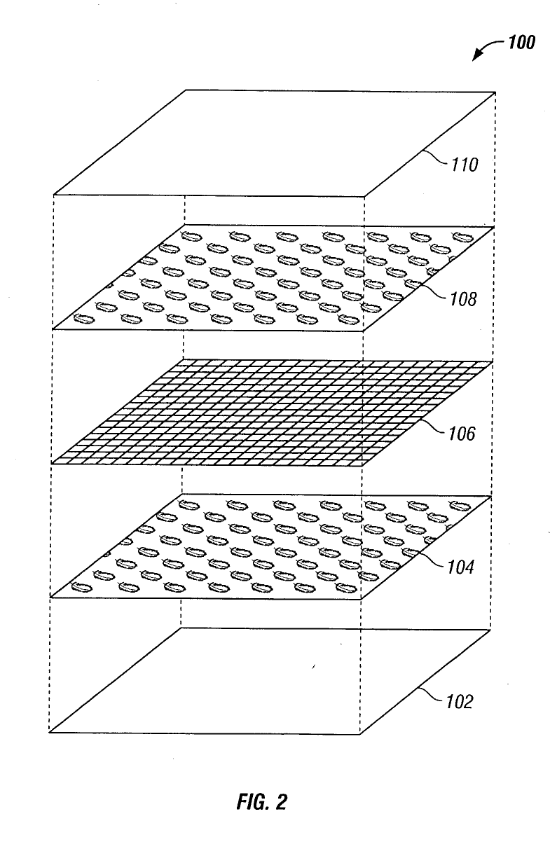

A first embodiment of the present invention is shown in FIG. 2. FIG. 2 shows an insulating composite structure at 100 in accordance with one embodiment of the present invention. Composite structure is composed of a cloth base layer 102, upon which is deposited a first down fill layer 104 composed of down feathers, though some alternative embodiments may dispense with a base layer 102, and simply deposit the first down fill layer 104 on a surface. A first adhesive web layer 106 is deposited onto down fill layer 104. In accordance with one embodiment, adhesive web layer 104 is composed of extruded rubber or plastic which is deposited in a semi-liquid state such that web layer 106 adheres to down fill layer 104. Plastics which may be suitable for use in adhesive web layer include most thermoplastics such as ABS (acrylonitrile-butadiene-styrene), polyethylene, acrylic, polyphenylene sulfide, polypropylene, polystyrene, Nylon, polyurethane, polyester, etc. Alternatively, it may also be possible to use thermosetting plastics such as polyester, polyurethane, or silicone. In another embodiment, adhesive web layer is comprised of thin strands of rubber, which remain sticky for a predetermined time period before solidifying. The use of various other materials in forming and applying adhesive layer 106, and alternative structures for adhesive layer 106 are contemplated in accordance with the present invention and should be apparent to those skilled in the material sciences in light of the present application.

Upon adhesive web layer 106 is deposited a second down fill layer 108 comprised of down feathers, which adhere to adhesive web layer 106. In accordance with one embodiment, adhesive web layer 106 is comprised of a grid of thin strands of rubber or plastic in a semi-liquid state, each adjacent parallel strand of the grid being separated by approximately the length of a down feather. Ideally each down feather will adhere to one or more of these strands. In accordance with one embodiment additional down fill layers (not shown) and additional adhesive web layers (not shown) are added to the down fabric structure 100.

Over down second down fill layer 108 is applied a cloth cover layer 110. Generally cloth cover layer 110 will be of the same material and structure as cloth layer 102, though alternative embodiments may use differing materials for layers 102 and 110.

Down fabric structure 100 comprises an insulative fabric that can be cut to any shape and will maintain a clump free consistency. Down fabric 100 can be cut to any shape because structure 100 does not have baffles containing loose material, which could leak if a cut were made through one of the baffles. In accordance with one embodiment, a seam (not shown) is sewn through the layers 102, 104, 106, 108, 110 in order to maintain the integrity of fabric structure 100 and to define a perimeter (not shown) for fabric structure 100. In accordance with one embodiment, cloth cover layers 102 and 110 are coated with an adhesive substance to further secure the down feathers of down fill layers 104 and 108 within the fabric structure 100.

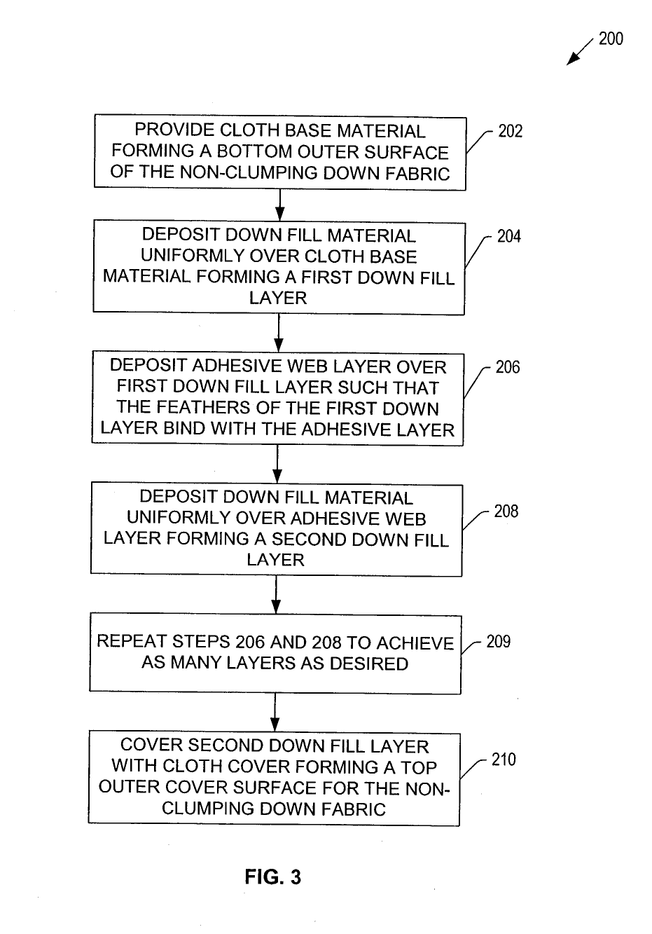

FIG. 3 illustrates a process at 200 for forming a non-clumping down fabric in accordance with one embodiment of the present invention. The process 200 begins with a step 202, in which a cloth base material is provided on a flat rigid surface. This cloth base material will eventually form a bottom outer surface of the finished non-clumping down fabric. Then in step 204, down feathers are deposited uniformly over the cloth base material forming a first down fill layer. Then in a step 206, an adhesive web layer is deposited over the first down fill layer such that the feathers composing the first down fill layer bind with the adhesive layer. In accordance with one embodiment, this adhesive layer is composed of a grid work of strands of semi-melted rubber or plastic. In accordance with one embodiment, this semi-liquid rubber grid is extruded onto the first down fill layer as it passes by on a conveyor belt. In accordance with an alternative embodiment, adhesive layer is simply a glue coated sheet of cloth or paper.

In a step 208, additional down feathers are deposited uniformly over the adhesive layer forming a second down fill layer. Preferably this is performed by some type of gravity dispenser, or may be blown onto the adhesive layer by some positive air pressure device. In accordance with one embodiment in which the adhesive layer is composed of semi-melted rubber or plastic, the down feathers must be deposited while the adhesive layer is in a semi-liquid state such that the feathers will bind with the adhesive layer. In accordance with a preferred embodiment, down feathers used include goose down feathers. Alternatively, any fibrous insulative material providing high thermal conductivity could be used for fill material in the down fill layers. In accordance with one embodiment, steps 206 through steps 208 are repeated to achieve as many layers as required to provide a desired thickness or insulative value.

Once all insulation layers have been formed a cloth cover is applied over the insulating layers in a step 210. Generally such a cover is similar to the cloth base layer provided in step 202, and is attached to the cloth base layer with a stitched seam. Alternatively a zippered seam may be used. In accordance with one embodiment, steps 202-210 are performed continuously on a moving conveyer.

In one embodiment of the present invention, an additional adhesive layer is deposited over the second down fill layer. In such an embodiment, this additional layer is similar to the adhesive layer deposited in step 206. In accordance with one embodiment additional layers of down fill and adhesive material are added in sequence until a desired thickness or level of insulation is reached.

In accordance with one embodiment, step 210 involves inserting alternating layers of insulation and adhesive web into a cloth packet similar in structure to a pillow case or a duvet cover. Such a cloth packet may include a buttoned or zippered edge suitable for sealing the insulative layers within the cloth packet.

In accordance with one embodiment, any loose down feathers are removed from the down fill layers before the cover is attached. In accordance with one embodiment, forced air is flowed across the down fill layers to remove feathers that have not bonded to the adhesive layer. This could be accomplished by means of commercially available blower devices normally used for blowing air or other gases. Various other means for removing excess material should be readily apparent to one skilled in the manufacture of textiles, in view of the present invention.

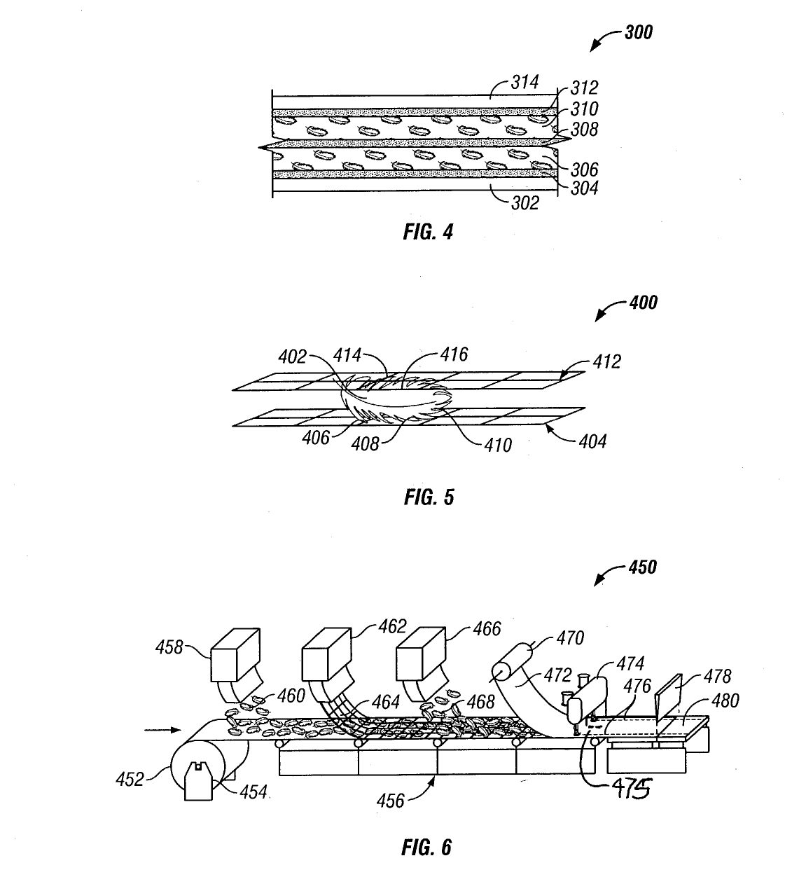

FIG. 4 shows a cut away view of a non-clumping down fabric at 300 created in accordance with one embodiment of the present invention. Cloth base layer 302 is coated with a first adhesive layer 304. First down fabric fill layer 306 is sandwiched between second adhesive layer 308 and first adhesive layer 304. Similarly second down fill layer 310 is sandwiched between second adhesive layer 308 and third adhesive layer 312. Third adhesive layer 312 also serves to secure cloth cover layer 314 to the down fabric structure 300. The resulting fabric 300 is flexible, and can be compressed, but will not clump, or become lumpy. In accordance with an alternative embodiment, additonal down fill layers 309 are sandwiched between alternating additional adhesive layers 311.

The down fabric 300 differs from the down fabric 100 (FIG. 2) in that down fabric 300 includes additional adhesive layers 304, 312 for securing down layers 306 and 310 to cover layers 302 and 314, respectively. The above embodiment is only one example of the numerous variations on the placement and structuring of such layers that are contemplated within the scope of the claims of the present invention.

FIG. 5 is a perspective view showing how an individual goose down feather is secured within one embodiment of the present invention at 400. Down feather 402 is secured to first adhesive layer 404 at locations 406, 408 and 410. Down feather 402 is also secured to second adhesive layer 412 at locations 414 and 416. In accordance with one embodiment, adhesive layers 404 and 412 are formed of strands of semi-liquid material arranged in a grid pattern. In accordance with such an embodiment, parallel strands of such a grid should be separated by a predetermined distance roughly equal to the span of a typical down feather such that most down feathers will adhere to more than one strand of each grid. Adhesive layers 404 and 412 are kept separated by feather 402, and are also connected via feather 402 forming a stable structure in which feather 402 is relatively secure, but still may be compressed, thereby retaining the feel of a traditional down filled article.

FIG. 6 illustrates a conveyor assembly system at 450 for manufacturing non-clumping down fabric in accordance with one embodiment of the present invention. A continues roll of cloth base material 452 is attached to a dispenser 454, which feeds the cloth base material onto a conveyor system 456. As cloth base material 452 travels down conveyor system 456 a down fill dispenser 458 deposits down fill material 460 evenly over the passing cloth base material 452 forming a first down fill layer 460. As first down fill layer 460 travels down the conveyor 456, an adhesive dispenser 462 extrudes a semi-liquid rubber webbing 464 over the passing down fill layer 460. This rubber webbing 464 adheres to the feathers of down fill layer 460 forming an adhesive layer 464. A second down fill dispenser 466 deposits additional down fill material 468 onto the rubber webbing 464 as it passes by on the conveyor system 456. Down fill material adheres to the rubber webbing 460 forming a second down fill layer 468. This second application of down fill material must be made while the rubber webbing material 464 is still in a semi-liquid state so that the second down fill layer will adhere to the webbing and form a secure structure.

Once all down fill layers and adhesive layers have been applied, a cloth cover dispenser 470 applies a cloth cover sheet 472 over the fabric forming a multi-layered composite fabric 480. A stitching machine 474 forms a seam 476 through the layers of the composite fabric 480, defining a border for the fabric. The stitching machine 474 may also be arranged to stich additional seams such as seam 475 in order to provide greater stability and prevention of clumping. Finally, cutter 478 cuts the down fabric 480 into predetermined lengths of fabrics suitable for use in clothing or other thermally insulative goods.

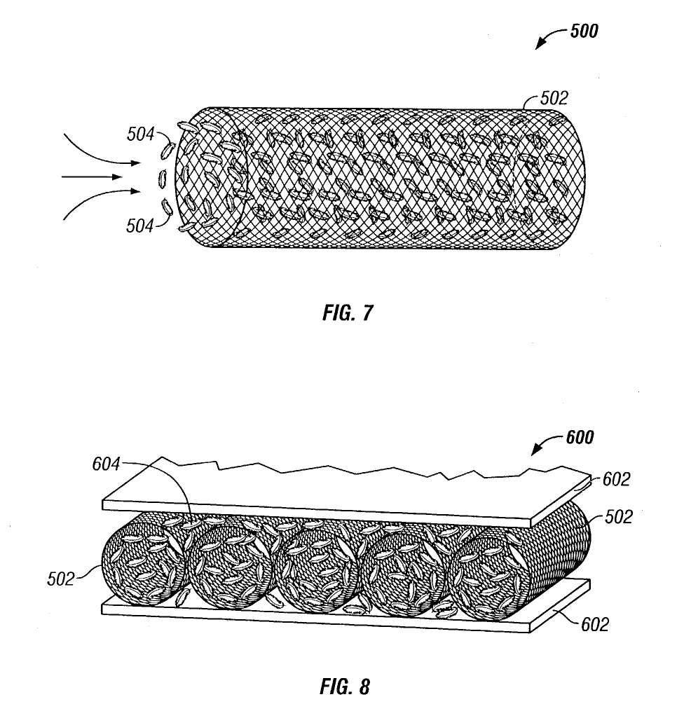

FIG. 7 illustrates a three dimensional down filled structure at 500 in accordance with one embodiment of the present invention. Down filled structure 500 is composed of a mesh tube 502. Mesh tube 502 is coated with an adhesive substance (not shown). Down fill material 504 is blown into the interior of mesh tube 502, adhering to the inner surface of mesh tube 502. Down fill material may also be deposited on the outside surface of mesh tube 502.

FIG. 8 is a cross-sectional end view of a non-clumping down fabric at 600 comprising a plurality of the three dimensional down filled structures of FIG. 6 in accordance with one embodiment of the present invention. Structure 600 is formed of a plurality of down filled mesh tubes 502 sandwiched between two cover sheets 602. In accordance with a preferred embodiment, one surface of each cover sheet 602 is coated with adhesive in order to secure the mesh tubes 502 and down fill 604.

While the invention has been particularly shown and described with reference to certain preferred embodiments, it will be understood by those skilled in the art that various alterations and modifications in form and detail may be made therein. Accordingly, it is intended that the following claims cover all such alterations and modifications as fall within the true spirit and scope of the invention.

What is claimed is:

1. A non-clumping insulating fabric suitable for use in various capacities comprising:
a fiber fill layer comprising a plurality of fibrous insulative elements;
an adhesive layer having an adhesive surface for binding material coming in contact with said adhesive surface;
wherein a substantial majority of said insulative elements of said fiber fill layer are bound to said adhesive surface; and
wherein said adhesive layer and said fiber fill layer form an insulating fabric material.

2. An insulating fabric as recited in claim 1, wherein said fiber fill layer is a first fiber fill layer, and wherein said plurality of fibrous insulative elements is a first plurality, further comprising a second plurality of fibrous insulative elements deposited upon said adhesive layer forming a second fiber fill layer, wherein at least some of said insulative elements of said second fiber fill layer are bound to said adhesive layer.

3. An insulating fabric as recited in claim 1, wherein said insulative elements include natural down feathers.

4. An insulating fabric as recited in claim 2, wherein said first and second plurality of fibrous insulative elements are primarily composed of goose down feathers.

5. An insulating fabric as recited in claim 1, wherein said adhesive layer and said fiber fill layer are at least partially enclosed by a cover for preventing said fibrous elements bound to said adhesive surface from being dislodged from said adhesive layer and for preventing said plurality of fibrous insulative elements from being soiled.

6. An insulating fabric as recited in claim 5, further comprising a substantially continues border defining a shape for said insulating fabric, wherein said substantially continues border includes a seam defining said shape and connecting said cover with said insulating fabric.

7. An insulating fabric as recited in claim 6, wherein said cover comprises an upper cover sheet and a lower cover sheet, wherein said seam binds said upper cover sheet with said lower cover sheet in order to fully enclose said fiber fill layer.

8. An insulating fabric as recited in claim 5, wherein said insulative elements bound to said adhesive layer are sufficiently bound to said adhesive layer to resist washing, and wherein said cover is of suitable cloth fabric such that said insulating fabric is machine washable.

9. An insulating fabric as recited in claim 5, further comprising:
a second adhesive layer, said second adhesive layer being deposited upon said second fiber fill layer such that at least some of the insulative elements of said second insulative layer bind to said second adhesive layer;
a third fiber fill layer applied over said second adhesive layer such that insulative elements of said third fiber fill layer bond with said second adhesive layer; and
wherein said cover is comprised of an upper sheet applied over said third fiber fill layer and a lower sheet in proximity with said first fiber fill layer, wherein said upper sheet and said lower sheet are connected with a common seam, and wherein said cover is composed of permeable cloth.

10. An insulating fabric as recited in claim 9, wherein said insulating fabric includes additional fiber fill layers and additional adhesive layers sufficient to create a desired thickness for said insulating fabric.

11. A method for manufacturing non-clumping insulating fabric suitable for use in clothing, bedding or specialized construction applications comprising:
providing a first plurality of insulative elements distributed over a surface forming a first insulative layer;
depositing upon said first insulative layer an adhesive layer having an adhesive surface for binding material coming in contact with said adhesive surface, wherein said first plurality of insulative elements bonds to said adhesive surface;
depositing upon said first adhesive layer a second plurality of insulative elements such that each element of said second plurality of insulative elements adheres to said adhesive layer forming a second insulative layer;
enclosing said first and second insulative layers in a cover such that said insulative elements are protected from an outside environment.

12. The method of claim 11, wherein said adhesive layer is a first adhesive layer, further comprising:
depositing a second adhesive layer upon said second insulating layer such that a plurality of the insulative elements comprising said second insulative layer are bound to said first adhesive layer and said second adhesive layer; and
depositing a third plurality of insulative elements upon said second adhesive layer such that said third plurality of insulative elements is bound to said second adhesive layer forming a third insulative layer, wherein additional insulating layers and adhesive layers may be added to form a desired thickness of non-clumping insulative fabric.

13. The method of claim 11, wherein said adhesive layer is deposited upon said first insulative layer by an extrusion process, wherein said adhesive layer comprises plastic webbing extruded in a semi-liquid state, and wherein said plastic webbing solidifies after said second insulative layer is deposited upon said adhesive layer.

14. The method of claim 13, wherein said plastic webbing includes at least one thermoplastic.

15. The method of claim 14, wherein said thermoplastic includes Polyester.

16. The method of claim 14, wherein said thermoplastic includes Nylon.

17. The method of claim 13, wherein said plastic webbing includes at least one thermosetting plastic.

18. The method of claim 11, wherein said cover includes a top sheet and a bottom sheet connected at a seam, wherein said seam defines a shape for said non-clumping insulating fabric.

19. The method of claim 11, wherein said first plurality of insulative elements include natural down feathers.

21. The method of claim 11, wherein said first plurality of insulative elements include styrafoam, wherein said insulating fabric is suitable for use in specialized construction applications.

22. A non-clumping down filled composite fabric suitable for use in both bedding and clothing, the fabric comprising:
a plurality of insulative layers, said insulative layers each including a plurality of down feathers;
a plurality of adhesive layers, each said adhesive layer having at least one adhesive surface for adhering material coming in contact with said adhesive surface, wherein each said down feather adheres to at least one of said plurality of adhesive layers, and wherein each said insulative layer is separated by one of said adhesive layers,
a cover enclosing said plurality of insulative layers and protecting said plurality of down feathers from being dislodged from at least one of said adhesive surfaces.

23. The composite fabric of claim 22 wherein each said adhesive layer comprises a mesh like structure including a plurality of substantially adjacent filaments, wherein said filaments are arranged such that a typical down feather will not pass through said mesh like structure.

24. The composite fabric of claim 23 wherein each said adhesive layer is created by extruding a first plurality of substantially parallel strands of semi-liquid adhesive material and extruding a second plurality of substantially parallel strands of semi-liquid adhesive material, wherein said first plurality of strands is not substantially parallel to said second plurality of strands, and wherein said first plurality of strands and said second plurality of strands form said mesh like structure.
